(19) United States
(12) Patent Application Publication
(10) Pub. No.: US 2026/0239198 A1
(43) Pub. Date: Aug. 13, 2026

(54) DATA TRANSMISSION METHOD FOR WIRELESS COMMUNICATION DEVICE, WIRELESS COMMUNICATION DEVICE, AND DATA TRANSMISSION SYSTEM

(71) Applicant: YEALINK (XIAMEN) NETWORK TECHNOLOGY CO., LTD., Xiamen (CN)

(72) Inventor: Fuyu WU, Xiamen (CN)

(73) Assignee: YEALINK (XIAMEN) NETWORK TECHNOLOGY CO., LTD., Xiamen (CN)

(21) Appl. No.: 19/438,426

(22) Filed: Dec. 31, 2025

Related U.S. Application Data
(63) Continuation of application No. PCT/CN2025/138690, filed on Nov. 28, 2025.

(30) Foreign Application Priority Data
Jan. 25, 2025 (CN) 202510120496.4

(51) Int. Cl. H04W 52/02

(52) U.S. Cl. CPC H04W 52/0216

(57) ABSTRACT

A data transmission method for a wireless communication device, a wireless communication device, and a data transmission system. The method includes: acquiring an energy-saving bandwidth upon receiving an energy-saving signal for enabling an energy-saving mode; wherein the energy-saving bandwidth is shorter than a transmission bandwidth before receiving the energy-saving signal; performing data sampling based on the energy-saving bandwidth to generate data to be transmitted; and transmitting the data to be transmitted to a target device, and controlling a radio frequency function to be turned off after transmission of the data to be transmitted is completed.

### CROSS-REFERENCE TO RELATED APPLICATION

This is a continuation application of International Patent Application PCT/CN2025/138690, filed on Nov. 28, 2025, which claims priority to Chinese Patent Application No. 202510120496.4, filed on Jan. 25, 2025 with the China National Intellectual Property Administration. The contents of the above applications are incorporated by reference herein in their entireties.

### TECHNICAL FIELD

The present disclosure relates to, but is not limited to, a data transmission method for a wireless communication device, a wireless communication device, and a data transmission system.

### BACKGROUND

To improve endurance capability of a wireless communication device, an Environmental Control Operation (ECO) strategy (also referred to as an energy-saving mode) is generally adopted at a software level, that is, dynamically adjusting the power of the radio frequency module in the communication device for receiving data and transmitting data.

### SUMMARY

In a first aspect, some embodiments of the present disclosure provide a data transmission method for a wireless communication device, including:
acquiring an energy-saving bandwidth upon receiving an energy-saving signal for enabling an energy-saving mode; wherein the energy-saving bandwidth is shorter than a transmission bandwidth before receiving the energy-saving signal;
performing data sampling based on the energy-saving bandwidth to generate data to be transmitted; and
transmitting the data to be transmitted to a target device, and controlling a radio frequency function to be turned off after transmission of the data to be transmitted is completed.

In a second aspect, some embodiments of the present disclosure further provide a wireless communication device, including a processor, a memory, and one or more computer programs stored in the memory and configured to be executable by the processor, wherein the one or more computer programs, when executed by the processor, cause the processor to implement the following operations:
acquiring an energy-saving bandwidth upon receiving an energy-saving signal for enabling an energy-saving mode; wherein the energy-saving bandwidth is shorter than a transmission bandwidth before receiving the energy-saving signal;
performing data sampling based on the energy-saving bandwidth to generate data to be transmitted; and
transmitting the data to be transmitted to a target device, and controlling a radio frequency function to be turned off after transmission of the data to be transmitted is completed.

In a third aspect, some embodiments of the present disclosure further provide a data transmission system, including: a wireless communication device and a target device;
wherein the wireless communication device is configured to acquire an energy-saving bandwidth upon receiving an energy-saving signal for enabling an energy-saving mode; wherein the energy-saving bandwidth is shorter than a transmission bandwidth before receiving the energy-saving signal;
perform data sampling based on the energy-saving bandwidth to generate data to be transmitted; and
transmit the data to be transmitted to the target device, and control a radio frequency function to be turned off after transmission of the data to be transmitted is completed, and
wherein the target device is configured to receive the data to be transmitted.

### BRIEF DESCRIPTION OF DRAWINGS

FIG. 1 is a schematic flowchart of a data transmission method for a wireless communication device provided by an embodiment of the present disclosure.

FIG. 2 is a schematic flowchart of a data transmission method for a wireless communication device provided by an embodiment of the present disclosure.

FIG. 3 is a schematic flowchart of a data transmission method for a wireless communication device provided by an embodiment of the present disclosure.

FIG. 4 is a schematic flowchart of a data transmission method for a wireless communication device provided by an embodiment of the present disclosure.

FIG. 5 is a schematic block diagram of a data transmission system provided by an embodiment of the present disclosure.

FIG. 6 is a schematic diagram of DECT frames and time slots provided by an embodiment of the present disclosure.

FIG. 7 is a schematic diagram of the radio frequency control table before and after adjustment provided by an embodiment of the present disclosure.

### DETAILED DESCRIPTION

Technical solutions in embodiments of the present disclosure will be clearly and completely described below with reference to the drawings in embodiments of the present disclosure. Apparently, the described embodiments are some embodiments of the present disclosure rather than all embodiments. Based on the embodiments of the present disclosure, all other embodiments obtained by a person of ordinary skill in the art without creative effort shall fall within the scope of the present disclosure.

To improve endurance capability of a wireless communication device, an Environmental Control Operation (ECO) strategy (also referred to as an energy-saving mode) is generally adopted at a software level, that is, dynamically adjusting the power of the radio frequency module in the communication device for receiving data and transmitting data. The approach is as follows: the radio frequency module dynamically reduces transmission power, shortens transmission and reception windows, or closes a radio frequency link in advance during idle time slots according to current channel quality and service load; and when a frame error rate fed back by a receiving end increases or signal strength is lower than a preset threshold, the radio frequency module is rapidly restored to rated power. This strategy can reduce power consumption to a certain extent while ensuring communication quality, and has become an energy-saving means of existing wireless communication devices. Therefore, the ECO strategy has been widely applied to short-range wireless communication systems such as Digital Enhanced Cordless Telecommunications (DECT), BLUETOOTH, and walkie-talkies, and is usually used in combination with technologies such as frequency hopping, time slot scheduling, and link adaptation, so as to achieve a balance between power consumption and communication quality.

To this end, embodiments of the present disclosure provide a wireless communication device, a wireless communication device, and a data transmission system.

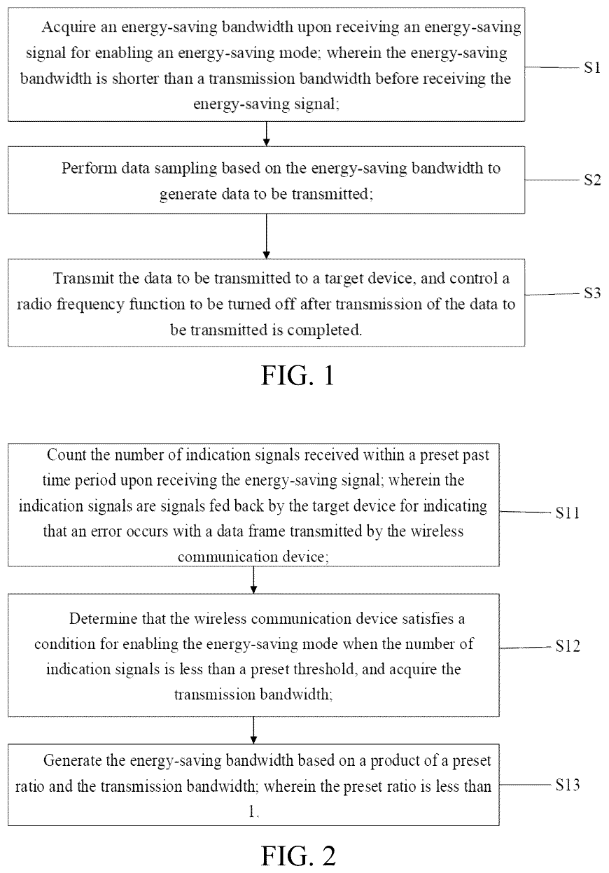

Referring to FIG. 1, which is a schematic flowchart of a data transmission method for a wireless communication device provided by an embodiment of the present disclosure, the method includes:
S1, acquiring an energy-saving bandwidth upon receiving an energy-saving signal for enabling an energy-saving mode, wherein the energy-saving bandwidth is shorter than a transmission bandwidth before receiving the energy-saving signal;
S2, performing data sampling based on the energy-saving bandwidth to generate data to be transmitted;
S3, transmitting the data to be transmitted to a target device, and controlling a radio frequency function to be turned off after transmission of the data to be transmitted is completed.

The data transmission method adopted in the embodiments of the present disclosure is applied to a data transmission system, for example, a wireless communication system, wherein the wireless communication system includes the wireless communication device and a target device. When the wireless communication device receives an energy-saving signal for enabling an energy-saving mode sent by the target device, the wireless communication device acquires a current energy-saving bandwidth, wherein the energy-saving bandwidth is shorter than a transmission bandwidth before receiving the energy-saving signal; the wireless communication device performs data sampling based on the energy-saving bandwidth to generate data to be transmitted; the wireless communication device transmits the data to be transmitted to a target device, and after transmission of the data to be transmitted is completed, controls a radio frequency function of the target device to be turned off. Here, a DECT wireless communication system is taken as an example. The wireless communication device may be a Handset (HS), and the target device may be a Base Station (BS). When the HS receives an energy-saving signal for enabling an energy-saving mode sent by the BS, the HS acquires a current energy-saving bandwidth, performs data sampling based on the energy-saving bandwidth to generate data to be transmitted, and transmits the data to the BS. After receiving the data, the BS controls a radio frequency function of the target device to be turned off. Alternatively, in the DECT wireless communication system, the target device may also be a Handset (HS), and the wireless communication device may also be a Base Station (BS).

It can be understood that, taking Digital Enhanced Cordless Telecommunications (DECT) as an example, a DECT air frame is transmitted once every 10 ms, and includes a total of 24 slots (slot0~slot23), including 12 downlink slots (from BS to HS) and 12 uplink slots (from HS to BS). The uplink and downlink are symmetric, that is, slot0 used by the Base Station (BS) is paired with slot12 used by the Handset (HS) (as shown in relevant content of FIG. 6 below). When the HS and the BS establish an air connection, one pair of slots (time slots) is selected for service communication. Each time slot includes a total of 480 bits, wherein a B-Field (320 bits) is configured to transmit custom data, such as voice data, and an X-Field is configured to transmit Cyclic Redundancy Check (CRC) of the B-Field. The embodiments of the present disclosure are not only applicable to DECT, but may also be applicable to wireless communication devices such as BLUETOOTH devices and walkie-talkies. It should be noted that, in the present embodiments, the wireless communication device refers to a device that needs to improve endurance capability, and the target device refers to another device that communicates with the wireless communication device. For example, in DECT communication, the wireless communication device may refer to the HS or BS that receives the energy-saving signal; in BLUETOOTH communication, the wireless communication device may refer to a BLUETOOTH headset or a smart terminal that receives the energy-saving signal.

In the data transmission method for a wireless communication device disclosed in embodiments of the present disclosure, the wireless communication device acquires an energy-saving bandwidth and performs data sampling based on the energy-saving bandwidth when receiving an energy-saving signal for enabling an energy-saving mode. By reducing a data transmission bandwidth to perform data sampling, a data size of data transmitted in a single transmission is reduced, enabling the wireless communication device to complete data transmission in a shorter time. In addition, after all data to be transmitted has been sent, a radio frequency function is controlled to be turned off, thereby effectively shortening an operating duration of a radio frequency module, reducing device power consumption, and improving endurance capability. Since the embodiments of the present disclosure do not rely on channel quality or frame error rate determination as a trigger or shutdown condition, but instead execute a one-time process and automatically restore regular scheduling after transmission is completed, there is no need to rely on dynamic link quality indicators. This approach achieves stable and quantifiable energy-saving effects while ensuring communication quality.

Optionally, as shown in FIG. 2, the acquiring of the energy-saving bandwidth includes:
S11, counting the number of indication signals received within a preset past time period upon receiving the energy-saving signal; wherein the indication signals are signals fed back by the target device for indicating that an error occurs with a data frame transmitted by the wireless communication device;
S12, determining that the wireless communication device satisfies a condition for enabling the energy-saving mode when the number of the indication signals is less than a preset threshold, and acquiring the transmission bandwidth;
S13, generating the energy-saving bandwidth based on a product of a preset ratio and the transmission bandwidth, the preset ratio being less than 1.

It can be understood that an energy-saving bandwidth adjustment manner adopted in the present disclosure performs condition determination based on historical statistical data of error indication signals, without requiring real-time monitoring of channel quality and service load during data transmission. This mechanism decouples energy-saving determination logic from real-time changing channel conditions and service load, thereby effectively simplifying complexity of the technical solution. Specifically, introduction of additional real-time feedback circuits or dynamic power control units into a radio frequency link is avoided, so that while effectively reducing power consumption, transmission quality is not affected, thereby achieving a balance between determination complexity and energy-saving effect.

In some possible embodiments of the present disclosure, during data frame transmission, a CRC verification code is configured as a frame tail for identifying an end of a data frame and for a receiving end to detect whether an error occurs during data transmission. It can be understood that when the receiving end detects errors in multiple received data frames within a short period of time, it may indicate that current communication quality between a transmitting end and the receiving end is relatively poor. For example, taking two consecutive detection periods each detecting that a CRC error rate threshold is 3% as an example, when the CRC error rate is greater than 3%, communication quality is considered to be relatively poor.

It can be understood that, to ensure communication quality, before reducing a transmission bandwidth to perform device energy saving, the embodiments of the present disclosure determine communication quality between the wireless communication device and the target device according to CRC verification results of data frames by the receiving end, that is, the target device. When, within a short period of time, signals fed back by the target device indicating errors in transmitted data frames, or signals requesting retransmission of data frames, are received, it indicates that current communication quality between the wireless communication device and the target device is relatively poor, and the transmission bandwidth cannot be reduced. In embodiments of the present disclosure, triggering conditions of energy-saving operations are decoupled from real-time channel parameters, and instead rely on CRC verification results that can directly and truly reflect an end-to-end transmission success rate, thereby effectively preventing inappropriate energy-saving strategies from being initiated during periods of poor channel quality, and thus achieving an optimized balance between communication reliability and energy-saving efficiency at a system level. In some possible embodiment of the present disclosure, when it is determined that current communication quality between the wireless communication device and the target device is relatively poor, energy saving may still be performed by enabling an ECO adjustment mode, or the transmission bandwidth may be reduced after performing handover, so as to achieve a purpose of improving endurance capability of the wireless communication device.

It should be further noted that, to ensure communication quality, the transmission bandwidth cannot be reduced excessively, and the more the transmission bandwidth is reduced, the greater an impact on voice quality will be. Therefore, the preset ratio may be adjusted according to data to be transmitted. In a specific disclosure scenario, the wireless communication device may be a DECT system device. In this case, the energy-saving bandwidth may be set according to a codec data sampling rate of a voice processing module. For example, a B-Field may be reduced by half, to 160 bits. Alternatively, when communication quality is excellent (for example, when error indication signals are extremely few), a higher energy-saving level may also be adopted, for example, reducing the B-Field to one quarter of an original value (that is, reduced to 80 bits), so as to achieve a maximum degree of energy saving.

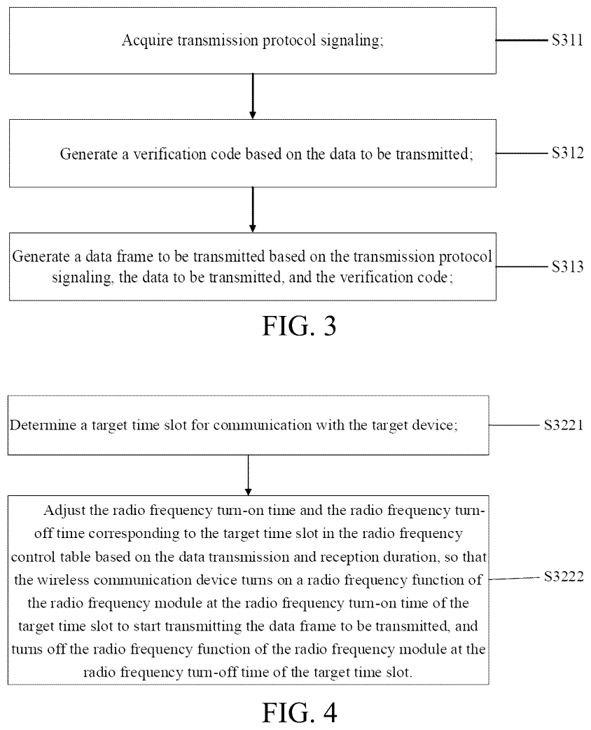

Optionally, referring to FIG. 3 and FIG. 4, the transmitting of the data to be transmitted to the target device includes:
S311, acquiring transmission protocol signaling;
S312, generating a verification code based on the data to be transmitted; and
S313, generating a data frame to be transmitted based on the transmission protocol signaling, the data to be transmitted, and the verification code.

Optionally, the generating of the data frame to be transmitted based on the transmission protocol signaling, the data to be transmitted, and the verification code includes:
generating a frame header of the data frame to be transmitted based on the transmission protocol signaling;
generating a data field of the data frame to be transmitted based on the data to be transmitted and the verification code; and
generating the data frame to be transmitted based on the frame header and the data field.

In some possible embodiments of the present disclosure, DECT standard signaling is transmitted through an A-Field shown in FIG. 6 below. In order not to affect standard signaling interaction of DECT, the present embodiment takes reduction of the B-Field as an example. Further, in the present embodiment, a CRC8 algorithm is adopted to calculate the verification code. It can be understood that the CRC in the original X-Field is generated using the complete B-Field data. Now, since the B-Field is not fully filled, CRC needs to be recalculated to replace the original X-Field. CRC calculated by the CRC8 algorithm is filled into the B-Field together. When the recalculated CRC and the data to be transmitted together constitute a data field, there is no data in the X-Field of the generated data frame to be transmitted, or in other words, there is no X-Field, thereby further reducing a size of the data frame.

Optionally, the controlling of the radio frequency function to be turned off after transmission of the data to be transmitted is completed includes:
calculating a data transmission and reception duration based on a data size of the data frame to be transmitted; and
determining that transmission of the data to be transmitted is completed after a transmission duration of the data frame to be transmitted reaches the data transmission and reception duration, and controlling the radio frequency function to be turned off.

Optionally, a radio frequency module of the wireless communication device is provided with a radio frequency control table; the radio frequency control table is configured to record radio frequency turn-on time and radio frequency turn-off time corresponding to each time slot;

The determining that transmission of the data to be transmitted is completed and the controlling of the radio frequency function to be turned off after a transmission duration of the data frame to be transmitted reaches the data transmission and reception duration include:
S3221, determining a target time slot for communication with the target device;
S3222, adjusting the radio frequency turn-on time and the radio frequency turn-off time corresponding to the target time slot in the radio frequency control table based on the data transmission and reception duration, so that the wireless communication device turns on a radio frequency function of the radio frequency module at the radio frequency turn-on time of the target time slot to start transmitting the data frame to be transmitted, and turns off the radio frequency function of the radio frequency module at the radio frequency turn-off time of the target time slot.

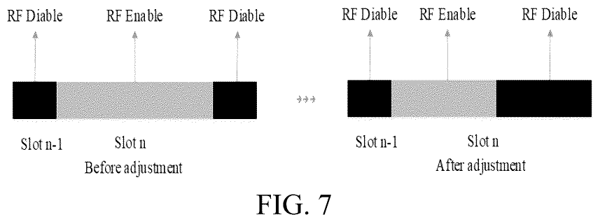

In some possible embodiments of the present disclosure, in a DECT protocol, establishing an air connection by using a full slot requires continuous transmission and reception for 10 ms (as shown in FIG. 6). Timing and duration of radio frequency transmission and reception of the HS and the BS are controlled by a Radio Frequency Control Table (RFCT). The RFCT table is loaded by a radio frequency control unit (RFCU) of a baseband microprocessor (BMP) underlying driver. The RFCT can precisely control at which bit each slot turns on radio frequency and turns off radio frequency. By adjusting timing of turning on and turning off radio frequency in the RFCT, a purpose of reducing transmitted data amount can be achieved. Since an amount of voice transmission in the B-Field is reduced, as shown in FIG. 7, it is necessary to adjust a length of data transmission and reception time in the RFCT, and turn off transmission radio frequency in advance according to a reduced data amount, thereby achieving reducing power consumption. By supporting HalfPayload, during a call process, power consumption of receiving and transmitting radio frequency can be reduced by (480 bit−316 bit)/480 bit=34.17%, thereby achieving improving call endurance.

Therefore, the data transmission method for a wireless communication device provided by embodiments of the present disclosure first reduces voice transmission amount by reducing bandwidth, recalculates CRC of voice data, then fills the voice data and CRC into an air data frame, and finally adjusts transmission length to turn off radio frequency in advance, thereby controlling turn-on duration of receiving and transmitting radio frequency of each frame, to improve endurance capability of the device. That is, the present embodiment precisely controls radio frequency turn-on duration based on an amount of data transmitted over air, is not limited to the DECT field, and control of lengths of receiving and transmitting data is not limited to using an RFCT adjustment method.

Another possible embodiment of the present disclosure provides a wireless communication device, including a processor, a memory, and a computer program stored in the memory and configured to be executable by the processor. When executing the computer program, the processor implements the data transmission method for a wireless communication device according to any one of the embodiments described above.

The wireless communication device may be a desktop computer, a notebook computer, a palmtop computer, a cloud server, or other computing devices. The wireless communication device may include, but is not limited to, a processor and a memory.

The processor may be a central processing unit (CPU), or may be another general-purpose processor, a digital signal processor (DSP), an application specific integrated circuit (ASIC), a field-programmable gate array (FPGA), or another programmable logic device, discrete gate or transistor logic device, or discrete hardware component. The general-purpose processor may be a microprocessor or the processor may also be any existing processor. The processor is a control center of a terminal device and connects various parts of the entire terminal device by using various interfaces and lines.

The memory may be configured to store the computer program. The processor implements various functions of the terminal device by running or executing the computer program stored in the memory and by invoking data stored in the memory. The memory may mainly include a program storage area and a data storage area, wherein the program storage area may store an operating system, at least one application program required for functions, and the like; and the data storage area may store data created according to use of a computing device (for example, a mobile phone), and the like. In addition, the memory may include a high-speed random access memory, and may also include a non-volatile memory, such as a hard disk, an internal memory, a plug-in hard disk, a smart media card (SMC), a secure digital (SD) card, a flash card, at least one magnetic disk storage device, a flash memory device, or another non-volatile solid-state storage device.

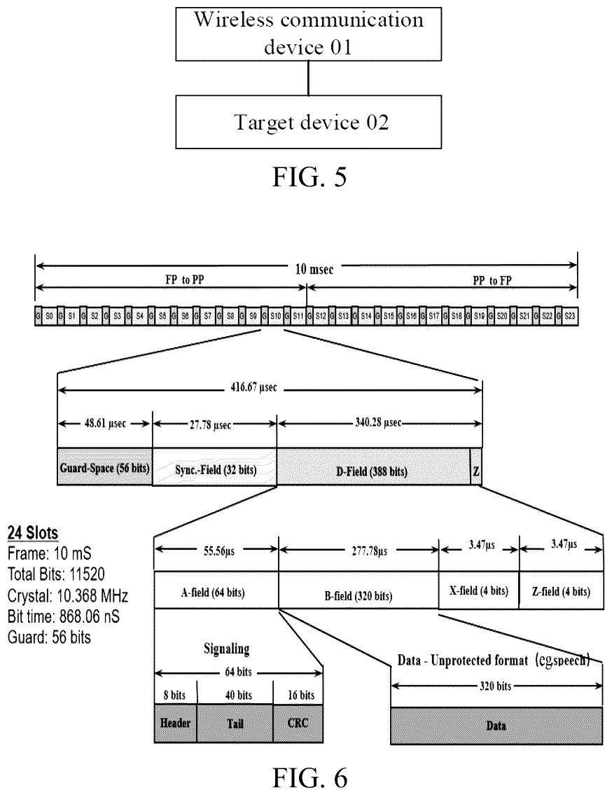

Referring to FIG. 5, which is a data transmission system provided by another possible embodiment of the present disclosure, the data transmission system includes: a wireless communication device 01 and a target device 02.

The wireless communication device 01 is configured to acquire an energy-saving bandwidth upon receiving an energy-saving signal for enabling an energy-saving mode; wherein the energy-saving bandwidth is shorter than a transmission bandwidth before receiving the energy-saving signal;
perform data sampling based on the energy-saving bandwidth to generate data to be transmitted; and
transmit the data to be transmitted to the target device 02, and control a radio frequency function to be turned off after transmission of the data to be transmitted is completed.

The target device 02 is configured to receive the data to be transmitted.

In some possible embodiments of the present disclosure, the wireless communication device 01 and the target device 02 may be a Handset (HS) and a Base Station (BS) in DECT, or may be a BLUETOOTH headset and a smart terminal, or a walkie-talkie and another walkie-talkie. It should be noted that, in the present embodiment, the wireless communication device refers to a device that needs to improve endurance capability, and the target device 02 refers to another device that communicates with the wireless communication device. For example, in DECT communication, the wireless communication device may refer to an HS or a BS that receives the energy-saving signal; and in BLUETOOTH communication, the wireless communication device may refer to a BLUETOOTH headset or a smart terminal that receives the energy-saving signal.

Optionally, the target device 02 is further configured to feed back a corresponding indication signal to the wireless communication device 01 upon detecting that an error occurs with a data frame transmitted by the wireless communication device 01.

The wireless communication device 01 is further configured to acquire the energy-saving bandwidth by:
counting the number of indication signals received within a preset past time period upon receiving the energy-saving signal;
determining that the wireless communication device 01 satisfies a condition for enabling the energy-saving mode when the number of the indication signals is less than a preset threshold, and acquiring the transmission bandwidth; and
generating the energy-saving bandwidth based on a preset ratio and the transmission bandwidth, the preset ratio being less than 1.

In some possible embodiments of the present disclosure, during data frame transmission, a CRC verification code is configured as a frame tail for identifying an end of a data frame and for a receiving end to detect whether an error occurs during data transmission. It can be understood that when the receiving end detects errors in multiple received data frames within a short period of time, it may indicate that current communication quality between a transmitting end and the receiving end is relatively poor.

Thus, to ensure communication quality, before reducing a transmission bandwidth to perform device energy saving, the wireless communication device 01 determines communication quality between the wireless communication device 01 and the target device 02 according to CRC verification results of data frames by the receiving end, that is, the target device 02. When, within a short period of time, signals fed back by the target device 02 indicating errors in transmitted data frames, or signals requesting retransmission of data frames, are received, it indicates that current communication quality between the wireless communication device 01 and the target device 02 is relatively poor, and the transmission bandwidth cannot be reduced. In embodiments of the present disclosure, when it is determined that current communication quality between the wireless communication device 01 and the target device 02 is relatively poor, energy saving may still be performed by enabling an ECO adjustment mode, or the transmission bandwidth may be reduced after performing handover, so as to achieve a purpose of improving endurance capability of the wireless communication device 01.

It should be further noted that, to ensure communication quality, the transmission bandwidth cannot be reduced excessively, and the more the transmission bandwidth is reduced, the greater an impact on voice quality will be. Therefore, the preset ratio may be adjusted according to data to be transmitted. In DECT, the energy-saving bandwidth may be set according to a codec data sampling rate of a voice processing module. A B-Field may be reduced by half, to 160 bits.

Optionally, the transmitting, by the wireless communication device 01, of the data to be transmitted to the target device 02 includes:
acquiring transmission protocol signaling;
generating a verification code based on the data to be transmitted;
generating a data frame to be transmitted based on the transmission protocol signaling, the data to be transmitted, and the verification code; and
transmitting the data frame to be transmitted to the target device 02.

In some possible embodiments of the present disclosure, DECT standard signaling is transmitted through an A-Field shown in FIG. 6 below. In order not to affect standard signaling interaction of DECT, the present embodiment takes reduction of the B-Field as an example. Further, in the present embodiment, a CRC8 algorithm is adopted to calculate the verification code. It can be understood that the CRC in the original X-Field is generated using the complete B-Field data. Now, since the B-Field is not fully filled, CRC needs to be recalculated to replace the original X-Field. CRC calculated by the CRC8 algorithm is filled into the B-Field together. When the recalculated CRC and the data to be transmitted together constitute a data field, there is no data in the X-Field of the generated data frame to be transmitted, or in other words, there is no X-Field, thereby further reducing a size of the data frame.

Optionally, the controlling of the radio frequency function to be turned off after transmission of the data to be transmitted is completed by the wireless communication device 01 includes:
calculating a data transmission and reception duration based on a data size of the data frame to be transmitted; and
after a transmission duration of the data frame to be transmitted reaches the data transmission and reception duration, determining that transmission of the data to be transmitted is completed, and controlling the radio frequency function to be turned off.

Optionally, a radio frequency module of the wireless communication device 01 is provided with a radio frequency control table; the radio frequency control table is configured to record radio frequency turn-on time and radio frequency turn-off time corresponding to each time slot;

The wireless communication device 01 determines that transmission of the data to be transmitted is completed and controls the radio frequency function to be turned off after a transmission duration of the data frame to be transmitted reaches the data transmission and reception duration by:
determining a target time slot for communication with the target device 02; and
adjusting the radio frequency turn-on time and the radio frequency turn-off time corresponding to the target time slot in the radio frequency control table based on the data transmission and reception duration, so that the wireless communication device 01 turns on a radio frequency function of the radio frequency module at the radio frequency turn-on time of the target time slot to start transmitting the data frame to be transmitted, and turns off the radio frequency function of the radio frequency module at the radio frequency turn-off time of the target time slot.

In some possible embodiments of the present disclosure, in a DECT protocol, establishing an air connection by using a full slot requires continuous transmission and reception for 10 ms. Timing and duration of radio frequency transmission and reception of the HS and the BS are controlled by a Radio Frequency Control Table (RFCT). The RFCT table is loaded by a radio frequency control unit (RFCU) of a baseband microprocessor (BMP) underlying driver. The RFCT can precisely control at which bit each slot turns on radio frequency and turns off radio frequency. By adjusting timing of turning on and turning off radio frequency in the RFCT, a purpose of reducing transmitted data amount can be achieved. Since an amount of voice transmission in the B-Field is reduced, as shown in FIG. 7, it is necessary to adjust a length of data transmission and reception time in the RFCT, and turn off transmission radio frequency in advance according to a reduced data amount, thereby achieving reducing power consumption. By supporting HalfPayload, during a call process, power consumption of receiving and transmitting radio frequency can be reduced by (480 bit−316 bit)/480 bit=34.17%, thereby achieving improving call endurance.

Therefore, the present embodiment first reduces voice transmission amount by reducing bandwidth, recalculates CRC of voice data, then fills the voice data and CRC into an air data frame, and finally adjusts transmission length to turn off radio frequency in advance, thereby controlling turn-on duration of receiving and transmitting radio frequency of each frame, to improve endurance capability of the device. That is, the present embodiment precisely controls radio frequency turn-on duration based on an amount of data transmitted over air, is not limited to the DECT field, and control of lengths of receiving and transmitting data is not limited to using an RFCT adjustment method.

The present embodiments provide a data transmission system. A wireless communication device 01 acquires an energy-saving bandwidth upon receiving an energy-saving signal for enabling an energy-saving mode; wherein the energy-saving bandwidth is shorter than a transmission bandwidth before receiving the energy-saving signal; performs data sampling based on the energy-saving bandwidth to generate data to be transmitted; transmits the data to be transmitted to a target device 02, and control a radio frequency function to be turned off after transmission of the data to be transmitted is completed. Thus, in the embodiments of the present disclosure, a data transmission bandwidth is reduced to perform data sampling, thereby reducing a data size of data transmitted in a single transmission, and enabling the wireless communication device to complete data transmission in a shorter time and reduce operating time of a radio frequency module, thereby saving device power consumption and achieving a purpose of improving endurance.

It should be noted that, for a person of ordinary skill in the art, various improvements and modifications may be made without departing from principles of the present application, and such improvements and modifications shall also fall within the scope of the present disclosure.

What is claimed is:

1. A data transmission method for a wireless communication device, comprising:
acquiring an energy-saving bandwidth upon receiving an energy-saving signal for enabling an energy-saving mode; wherein the energy-saving bandwidth is shorter than a transmission bandwidth before receiving the energy-saving signal;
performing data sampling based on the energy-saving bandwidth to generate data to be transmitted; and
transmitting the data to be transmitted to a target device, and controlling a radio frequency function to be turned off after transmission of the data to be transmitted is completed.

2. The data transmission method for the wireless communication device of claim 1, wherein the acquiring of the energy-saving bandwidth comprises:
counting a number of one or more indication signals received within a preset past time period upon receiving the energy-saving signal; wherein the indication signal is a signal fed back by the target device and configured to indicate that an error occurs with a data frame transmitted by the wireless communication device;
determining that the wireless communication device satisfies a condition for enabling the energy-saving mode when the number of the indication signals is less than a preset threshold, and acquiring the transmission bandwidth; and
generating the energy-saving bandwidth based on a product of a preset ratio and the transmission bandwidth, the preset ratio being less than 1.

3. The data transmission method for the wireless communication device of claim 1, wherein the transmitting of the data to be transmitted to the target device comprises:
acquiring transmission protocol signaling;
generating a verification code based on the data to be transmitted;
generating a data frame to be transmitted based on the transmission protocol signaling, the data to be transmitted, and the verification code; and
transmitting the data frame to be transmitted to the target device.

4. The data transmission method for the wireless communication device of claim 3, wherein the generating of the data frame to be transmitted based on the transmission protocol signaling, the data to be transmitted, and the verification code comprises:
generating a frame header of the data frame to be transmitted based on the transmission protocol signaling;
generating a data field of the data frame to be transmitted based on the data to be transmitted and the verification code; and
generating the data frame to be transmitted based on the frame header and the data field.

5. The data transmission method for the wireless communication device of claim 4, wherein the controlling of the radio frequency function to be turned off after transmission of the data to be transmitted is completed comprises:
calculating a data transmission and reception duration based on a data size of the data frame to be transmitted; and
determining that transmission of the data to be transmitted is completed when a transmission duration of the data frame to be transmitted reaches the data transmission and reception duration, and controlling the radio frequency function to be turned off.

6. The data transmission method for the wireless communication device of claim 5, wherein a radio frequency module of the wireless communication device is provided with a radio frequency control table; wherein the radio frequency control table is configured to record radio frequency turn-on time and radio frequency turn-off time corresponding to each time slot;
wherein the determining that transmission of the data to be transmitted is completed when the transmission duration of the data frame to be transmitted reaches the data transmission and reception duration and the controlling of the radio frequency function to be turned off comprise:
determining a target time slot for communication with the target device; and
adjusting the radio frequency turn-on time and the radio frequency turn-off time corresponding to the target time slot in the radio frequency control table based on the data transmission and reception duration, such that the wireless communication device turns on the radio frequency function of the radio frequency module at the radio frequency turn-on time of the target time slot to start transmitting the data frame to be transmitted, and turns off the radio frequency function of the radio frequency module at the radio frequency turn-off time of the target time slot.

7. The data transmission method for the wireless communication device of claim 1, wherein the wireless communication device is a base station in Digital Enhanced Cordless Telecommunications (DECT) communication, and the target device is a handset in the DECT communication; or
wherein the wireless communication device is the handset in the DECT communication, and the target device is the base station in the DECT communication.

8. A wireless communication device, comprising a processor, a memory, and one or more computer programs stored in the memory and configured to be executable by the processor, wherein the one or more computer programs, when executed by the processor, cause the processor to implement the following operations:
acquiring an energy-saving bandwidth upon receiving an energy-saving signal for enabling an energy-saving mode; wherein the energy-saving bandwidth is shorter than a transmission bandwidth before receiving the energy-saving signal;
performing data sampling based on the energy-saving bandwidth to generate data to be transmitted; and
transmitting the data to be transmitted to a target device, and controlling a radio frequency function to be turned off after transmission of the data to be transmitted is completed.

9. The wireless communication device of claim 8, wherein the one or more computer programs, when executed by the processor, cause the processor to implement the operation of acquiring the energy-saving bandwidth by performing the following operations:
counting a number of one or more indication signals received within a preset past time period upon receiving the energy-saving signal; wherein the indication signal is a signal fed back by the target device and configured to indicate that an error occurs with a data frame transmitted by the wireless communication device;
determining that the wireless communication device satisfies a condition for enabling the energy-saving mode when the number of the indication signals is less than a preset threshold, and acquiring the transmission bandwidth; and
generating the energy-saving bandwidth based on a product of a preset ratio and the transmission bandwidth, the preset ratio being less than 1.

10. The wireless communication device of claim 8, wherein the one or more computer programs, when executed by the processor, cause the processor to implement the operation of transmitting the data to be transmitted to the target device by performing the following operations:
acquiring transmission protocol signaling;
generating a verification code based on the data to be transmitted;
generating a data frame to be transmitted based on the transmission protocol signaling, the data to be transmitted, and the verification code; and
transmitting the data frame to be transmitted to the target device.

11. The wireless communication device of claim 10, wherein the one or more computer programs, when executed by the processor, cause the processor to implement the operation of generating the data frame to be transmitted based on the transmission protocol signaling, the data to be transmitted, and the verification code by performing the following operations:
generating a frame header of the data frame to be transmitted based on the transmission protocol signaling;
generating a data field of the data frame to be transmitted based on the data to be transmitted and the verification code; and
generating the data frame to be transmitted based on the frame header and the data field.

12. The wireless communication device of claim 11, wherein the one or more computer programs, when executed by the processor, cause the processor to implement the operation of controlling the radio frequency function to be turned off after transmission of the data to be transmitted is completed by performing the following operations:
calculating a data transmission and reception duration based on a data size of the data frame to be transmitted; and
determining that transmission of the data to be transmitted is completed when a transmission duration of the data frame to be transmitted reaches the data transmission and reception duration, and controlling the radio frequency function to be turned off.

13. The wireless communication device of claim 12, wherein a radio frequency module of the wireless communication device is provided with a radio frequency control table; wherein the radio frequency control table is configured to record radio frequency turn-on time and radio frequency turn-off time corresponding to each time slot;
wherein the one or more computer programs, when executed by the processor, cause the processor to implement the operation of determining that transmission of the data to be transmitted is completed when the transmission duration of the data frame to be transmitted reaches the data transmission and reception duration and controlling the radio frequency function to be turned off by performing the following operations:
determining a target time slot for communication with the target device; and
adjusting the radio frequency turn-on time and the radio frequency turn-off time corresponding to the target time slot in the radio frequency control table based on the data transmission and reception duration, such that the wireless communication device turns on the radio frequency function of the radio frequency module at the radio frequency turn-on time of the target time slot to start transmitting the data frame to be transmitted, and turns off the radio frequency function of the radio frequency module at the radio frequency turn-off time of the target time slot.

14. The wireless communication device of claim 8, wherein the wireless communication device is a base station in DECT communication, and the target device is a handset in the DECT communication; or
wherein the wireless communication device is the handset in the DECT communication, and the target device is the base station in the DECT communication.

15. A data transmission system, comprising: a wireless communication device and a target device;
wherein the wireless communication device is configured to acquire an energy-saving bandwidth upon receiving an energy-saving signal for enabling an energy-saving mode; wherein the energy-saving bandwidth is shorter than a transmission bandwidth before receiving the energy-saving signal;
perform data sampling based on the energy-saving bandwidth to generate data to be transmitted; and
transmit the data to be transmitted to the target device, and control a radio frequency function to be turned off after transmission of the data to be transmitted is completed, and
wherein the target device is configured to receive the data to be transmitted.

16. The data transmission system of claim 15, wherein the target device is further configured to feed back a corresponding indication signal to the wireless communication device upon detecting that an error occurs with a data frame transmitted by the wireless communication device, and
wherein the wireless communication device is further configured to acquire the energy-saving bandwidth by:
counting a number of one or more indication signals received within a preset past time period upon receiving the energy-saving signal;
determining that the wireless communication device satisfies a condition for enabling the energy-saving mode when the number of the indication signals is less than a preset threshold, and acquiring the transmission bandwidth; and
generating the energy-saving bandwidth based on a product of a preset ratio and the transmission bandwidth, the preset ratio being less than 1.

17. The data transmission system of claim 15, wherein the wireless communication device is further configured to transmit the data to be transmitted to the target device by:
acquiring transmission protocol signaling;
generating a verification code based on the data to be transmitted;
generating a data frame to be transmitted based on the transmission protocol signaling, the data to be transmitted, and the verification code; and
transmitting the data frame to be transmitted to the target device.

18. The data transmission system of claim 17, wherein the wireless communication device is further configured to transmit the data frame to be transmitted to the target device, and control the radio frequency function to be turned off after transmission of the data to be transmitted is completed by:
calculating a data transmission and reception duration based on a data size of the data frame to be transmitted; and
determining that transmission of the data to be transmitted is completed when a transmission duration of the data frame to be transmitted reaches the data transmission and reception duration, and controlling the radio frequency function to be turned off.

19. The data transmission system of claim 18, wherein a radio frequency module of the wireless communication device is provided with a radio frequency control table; wherein the radio frequency control table is configured to record radio frequency turn-on time and radio frequency turn-off time corresponding to each time slot;
wherein the wireless communication device is further configured to determine that transmission of the data to be transmitted is completed when the transmission duration of the data frame to be transmitted reaches the data transmission and reception duration and control the radio frequency function to be turned off by:
determining a target time slot for communication with the target device; and
adjusting the radio frequency turn-on time and the radio frequency turn-off time corresponding to the target time slot in the radio frequency control table based on the data transmission and reception duration, such that the wireless communication device turns on the radio frequency function of the radio frequency module at the radio frequency turn-on time of the target time slot to start transmitting the data frame to be transmitted, and turns off the radio frequency function of the radio frequency module at the radio frequency turn-off time of the target time slot.

20. The data transmission system of claim 15, wherein the wireless communication device is a base station in DECT communication, and the target device is a handset in the DECT communication; or
wherein the wireless communication device is the handset in the DECT communication, and the target device is the base station in the DECT communication.
